(19) United States
(12) Patent Application Publication
(10) Pub. No.: US 2025/0385627 A1
(43) Pub. Date: Dec. 18, 2025

(54) SYSTEM AND METHOD FOR INCREASING MAXIMUM MOTOR TORQUE AT ZERO SPEED AND LOW SPEEDS

(71) Applicant: Dana Heavy Vehicle Systems Group, LLC, Maumee, OH (US)

(72) Inventors: Ahmad GHADERI, Rochester Hills, MI (US); Ruisheng SHI, Montreal (CA); Jeremy M. FRENZNICK, Brighton, MI (US)

(21) Appl. No.: 18/745,088

(22) Filed: Jun. 17, 2024

(51) Int. Cl. H02P 21/14; B60L 15/02; B60L 15/20; H02P 6/08; H02P 27/06

(52) U.S. Cl. CPC H02P 21/14; B60L 15/025; B60L 15/20; H02P 6/08; H02P 27/06; B60L 2240/421; B60L 2240/423; B60L 2240/429

(57) ABSTRACT

Methods and system for operating an electric machine are shown. In one example, direct current and quadrature current that is supplied to an electric machine via an inverter are adjusted in response to a difference between two angles. The method and system may be particularly useful for operating the electric machine at lower rotational speeds.

### TECHNICAL FIELD

The present disclosure relates to controlling torque output of an electric machine at zero rotational speed and lower rotational speeds.

### BACKGROUND AND SUMMARY

An electric machine may be supplied with an alternating current as the electric machine rotates. The electric machine may be a multi-phase (e.g., three-phase or six-phase) electric machine that is supplied with sinusoidal electric current via an inverter. The inverter may supply leg currents that vary from zero to some maximum value. Each of the inverter legs may supply electric current to the electric machine via two switches per inverter leg. As the electric machine rotates, heat generated in the switches is distributed across the legs over time. However, when the electric machine is at zero rotational speed, the inverter leg currents do not vary. If the rotor of the electric machine is at a position where one of the leg currents is at its sinusoidal maximum current, the heat that is generated in the one leg will exceed heat that is generated in the other legs which may result in degradation of a switch in the one leg. One way to mitigate this issue may be to reduce current flow through the inverter legs when electric machine rotational speed is zero. However, reducing the electric current flow through the inverter legs reduces electric machine torque output. In some examples, torque output of an electric machine may be reduced by more than 15% as compared to maximum output torque of the electric machine at higher speeds. However, reducing torque output of the electric machine reduces vehicle and electric machine performance. Another way to reduce a possibility of degradation in legs of the inverter is to increase a capacity of conductors and switches in the inverter legs. But, this remedy may increase system financial expense and weight.

The inventors herein have recognized the above-mentioned issues and have provided a method for operating an electric machine, comprising: via a controller, generating a dq phase angle in response to a motor maximum torque per ampere angle and an inverter current angle; and operating the electric machine according to the dq phase angle.

By generating a dq phase angle for an electric machine in response to a motor maximum torque per ampere angle and an inverter current angle, it may be possible for an electric machine to generate higher torques at lower electric machine speeds for a particular amount of current flow into the electric machine. Electric machine direct and quadrature currents may be adjusted according to the dq phase angle so that the electric machine may provide additional torque for a particular amount of electric current.

The present description may provide several advantages. In particular, the approach may increase an amount of torque that may be generated at zero rotational speed for an electric machine. Further, the approach may reduce a possibility of degrading of switches in an inverter. Additionally, the approach may lower system financial expense to achieve higher torque levels at lower electric machine rotational speeds.

It is to be understood that the summary above is provided to introduce in simplified form a selection of concepts that are further described in the detailed description. It is not meant to identify key features of the claimed subject matter, the scope of which is defined uniquely by the claims that follow the detailed description. Furthermore, the claimed subject matter is not restricted to implementations that solve any disadvantages noted above or in any part of this disclosure.

### BRIEF DESCRIPTION OF THE DRAWINGS

FIG. 1 is an illustration of an example vehicle that includes an electric vehicle propulsion system.

FIG. 2 shows a plot that illustrates an angle I_Ang between lq and ld currents.

FIG. 3 shows a plot of electric machine torque with respect to I_Ang.

FIGS. 4-15 show plots of electric machine torque with respect to different electric machine operating conditions.

FIG. 16 shows a block diagram of a method to determine a maximum torque for an electric machine.

FIGS. 17-36 show plots of operating conditions for an electric machine.

FIG. 37 shows a block diagram of a method to determine I_Ang for lower electric machine rotational speeds.

FIG. 38 shows a second block diagram of a method to determine l_Ang for both lower and higher electric machine rotational speeds.

### DETAILED DESCRIPTION

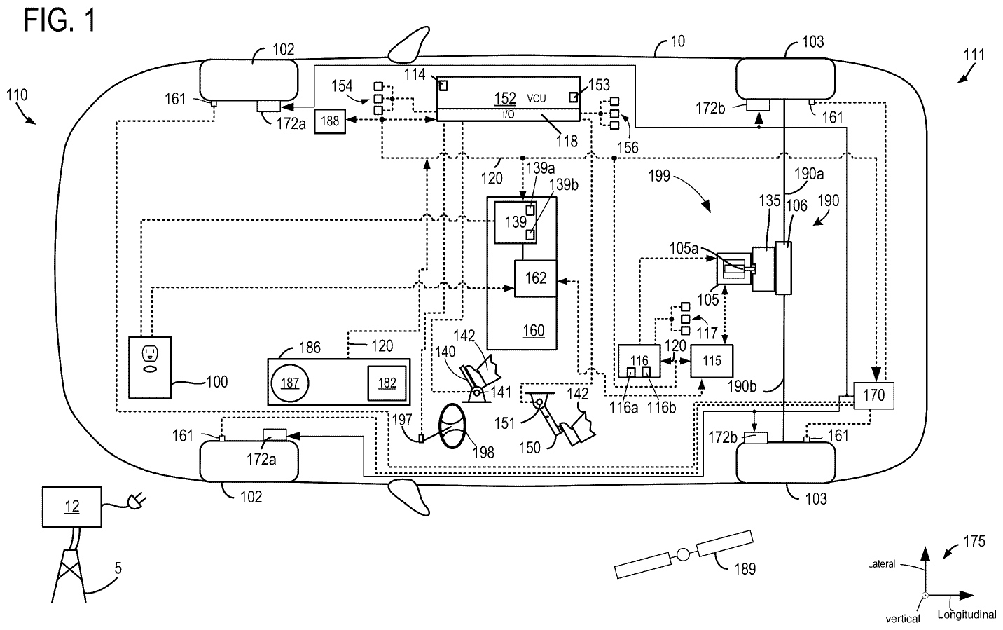

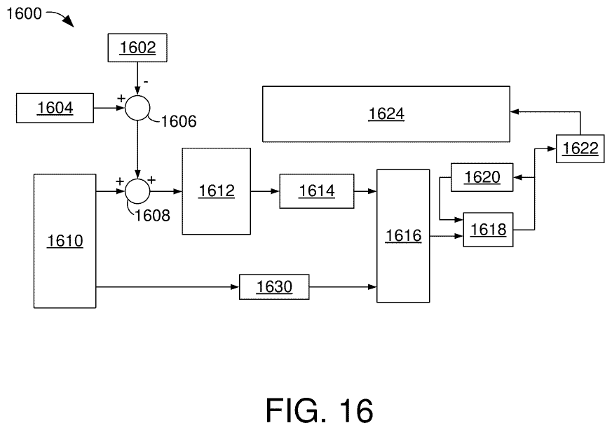

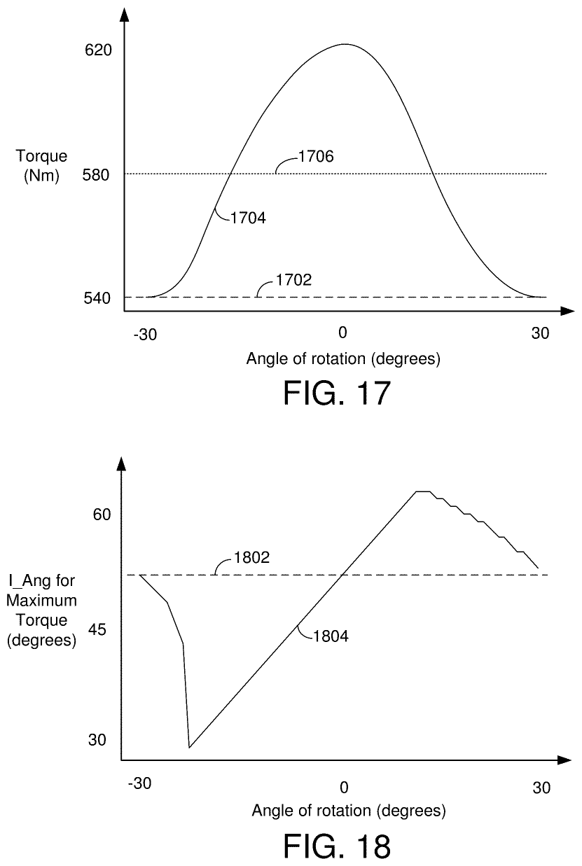

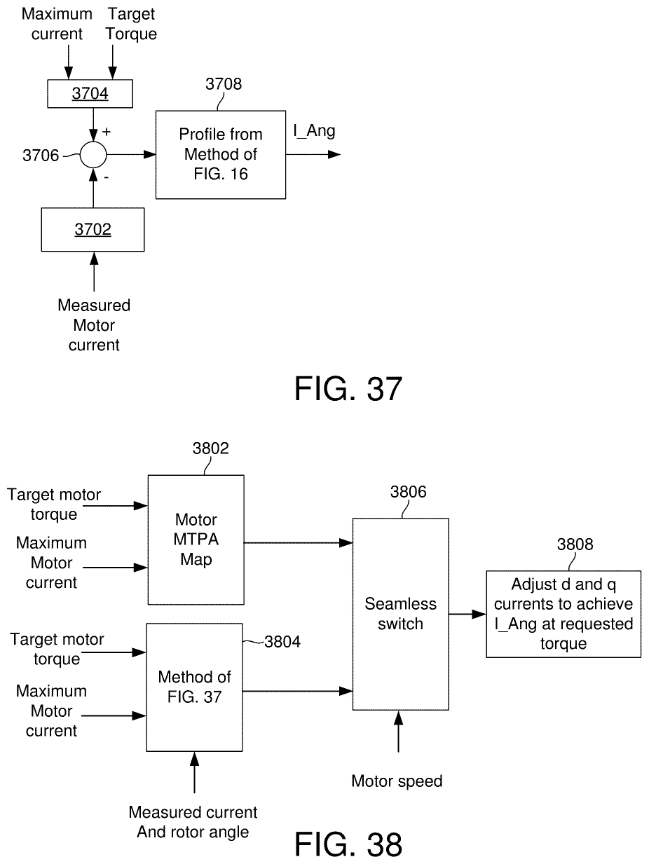

A method and system for controlling electric machine torque at low rotational speeds including zero rotational speed is described. The system and method determine a direct-quadrature (dq) current phase angle according to electric machine maximum torque per ampere (motor MTPA) and inverter current angle (e.g., an angle of inverter current with respect to the start of the present cycle of the current output of the inverter for a particular phase leg of the inverter (e.g., phase A), where the inverter current angle may vary from 0 to 360 degrees). Plots of various electric machine operating conditions are shown in FIGS. 1-15. Further, a block diagram of a method to determine the dq current phase angle is shown at FIG. 16. The method and system that are described herein may maximize electric machine torque at zero rotational speed of the electric machine by adjusting direct and quadrature currents according to the dq current phase. FIGS. 17-36 show prophetic example electric machine operating conditions according to the method of FIG. 16. FIGS. 37 and 38 are methods that may be applied in cooperation with the method of FIG. 16.

FIG. 1 illustrates an example vehicle propulsion system 199 for vehicle 10. In FIG. 1 mechanical connections between the various components are illustrated as solid lines, whereas electrical connections between various components are illustrated as dashed lines. Vehicle front end is indicated at 110 and vehicle rear end is indicated at 111. Vehicle 10 travels in a forward direction when vehicle front end 110 leads movement of vehicle 10. Vehicle 10 travels in a reverse direction when vehicle rear end 111 leads movement of vehicle 10. In this example, vehicle 10 is a rear wheel drive vehicle, but in other examples, vehicle 10 may be a four-wheel drive or front wheel drive vehicle.

Vehicle propulsion system 199 includes a propulsion source 105 (e.g., an electric machine, such as a motor), but in other examples two or more propulsion sources may be provided. In one example, propulsion source 105 may be a synchronous or induction electric machine that may operate as a motor or generator. Vehicle propulsion system 199 also includes a transmission 135. The propulsion source 105 is fastened to the transmission 135 and propulsion source 105 delivers power from its rotor 105a to transmission 135. Transmission 135 may be mechanically coupled to differential gears 106. Differential gears 106 may be coupled to two axle shafts, including a first or right axle shaft 190a and a second or left axle shaft 190b. Vehicle 10 further includes front wheels 102 and rear wheels 103.

The transmission 135 may be referred to as a step ratio transmission. Transmission 135 may include one or more clutch actuators (not shown) to shift one or more clutches. Electric power inverter 115 is electrically coupled to propulsion source 105 to convert DC power to alternating current (AC) and vise-versa. Powertrain controller 116 is electrically coupled to sensors 117 and actuators of vehicle propulsion system 199. For example, sensors 117 may include, but are not limited to inverter switch temperature sensors, electric machine winding temperature sensors, bus bar temperature sensors, etc.

Transmission 135 may transfer mechanical power to or receive mechanical power from differential gears 106. Differential gears 106 may transfer mechanical power to or receive mechanical power from rear wheels 103 via right axle shaft 190a and left axle shaft 190b. Propulsion source 105 may consume alternating current (AC) electrical power provided via electric power inverter 115. Alternatively, propulsion source 105 may provide AC electrical power to electric power inverter 115. Electric power inverter 115 may be provided with high voltage direct current (DC) power from battery 160 (e.g., a traction battery, which also may be referred to as an electric energy storage device or battery pack). Electric power inverter 115 may convert the DC electrical power from battery 160 into AC electrical power for propulsion source 105. Alternatively, electric power inverter 115 may be provided with AC power from propulsion source 105. Electric power inverter 115 may convert the AC electrical power from propulsion source 105 into DC power to store in battery 160. Electric power inverter 115 may be commanded via powertrain controller 116 to provide direct current and quadrature current to propulsion source 105 via space vector modulation.

Propulsion source 105 may transfer mechanical power to or receive mechanical power from transmission 135. As such, transmission 135 may be a multi-speed gear set that may shift between gear ratios when commanded via powertrain controller 116. Powertrain controller 116 includes a processor 116a and memory 116b. Memory 116b (e.g., storage media) may include read exclusive memory, random access memory, and keep alive memory. The memory may be programmed with computer readable data representing instructions that are executable by a processor for performing the methods and control techniques described herein as well as other variants that are anticipated but not specifically listed. As such, control techniques, methods, and the like expanded upon herein may be stored as instructions in non-transitory memory.

Battery 160 may periodically receive electrical energy from a power source such as a stationary power grid 5 residing external to the vehicle (e.g., not part of the vehicle). As a non-restricted example, vehicle propulsion system 199 may be configured as a plug-in electric vehicle (EV), whereby electrical energy may be supplied to battery 160 via the stationary power grid 5 and charging station 12. Electric charge may be delivered to battery 160 via plug receptacle 100.

Battery 160 may include a BMS controller 139 (e.g., a battery management system controller) and an electrical power distribution box 162. BMS controller 139 may provide charge balancing between energy storage elements (e.g., battery cells) and communication with other vehicle controllers (e.g., vehicle control unit 152). BMS controller 139 includes a core processor 139a and memory 139b (e.g., random-access memory, read-exclusive memory, and keep-alive memory).

Vehicle 10 may include a vehicle control unit (VCU) 152 that may communicate with electric power inverter 115, powertrain controller 116, friction or foundation caliper controller 170, global positioning system (GPS) 188, BMS controller 139, and dashboard 186 and components included therein via controller area network (CAN) 120. VCU 152 includes memory 114, which may include read-exclusive memory (ROM or non-transitory memory) and random access memory (RAM). VCU also includes a digital processor or central processing unit (CPU) 153, and inputs and outputs (I/O) 118 (e.g., digital inputs including counters, timers, and discrete inputs, digital outputs, analog inputs, and analog outputs). VCU may receive signals from sensors 154 and provide control signal outputs to actuators 156. Sensors 154 may include but are not restricted to lateral accelerometers, longitudinal accelerometers, yaw rate sensors, inclinometers, temperature sensors, battery voltage and current sensors, and other sensors described herein. Additionally, sensors 154 may include steering angle sensor 197, driver demand pedal position sensor 141, vehicle range finding sensors including radio detection and ranging (RADAR), light detection and ranging (LIDAR), sound navigation and ranging (SONAR), and caliper application pedal position sensor 151. Actuators may include but are not constrained to inverters, transmission controllers, display devices, human/machine interfaces, friction caliper systems, and battery controller described herein.

Driver demand pedal position sensor 141 is shown coupled to driver demand pedal 140 for determining a degree of application of driver demand pedal 140 by human 142. Caliper application pedal position sensor 151 is shown coupled to caliper application pedal 150 for determining a degree of application of caliper application pedal 150 by human 142. Steering angle sensor 197 is configured to determine a steering angle according to a position of steering wheel 198.

Vehicle propulsion system 199 is shown with a global position determining system 188 that receives timing and position data from one or more GPS satellites 189. Global positioning system may also include geographical maps in ROM for determining the position of vehicle 10 and features of roads that vehicle 10 may travel on.

Vehicle propulsion system 199 may also include a dashboard 186 that an operator of the vehicle may interact with. Dashboard 186 may include a display system 187 configured to display information to the vehicle operator. Display system 187 may comprise, as a non-restricting example, a touchscreen, or human machine interface (HMI), display which enables the vehicle operator to view graphical information as well as input commands. In some examples, display system 187 may be connected wirelessly to the internet (not shown) via VCU 152. As such, in some examples, the vehicle operator may communicate via display system 187 with an internet site or software application (app) and VCU 152.

Dashboard 186 may further include an operator interface 182 via which the vehicle operator may adjust the operating status of the vehicle. Specifically, the operator interface 182 may be configured to activate and/or deactivate operation of the vehicle driveline (e.g., propulsion source 105) based on an operator input. Further, an operator may request an axle mode (e.g., park, reverse, neutral, drive) via the operator interface. Various examples of the operator interface 182 may include interfaces that utilize a physical apparatus, such as a key, that may be inserted into the operator interface 182 to activate the vehicle propulsion system 199 including propulsion source 105 and to turn on the vehicle 10. The apparatus may be removed to shut down the transmission 135 and propulsion source 105 to turn off vehicle 10. Propulsion source 105 may be activated via supplying electric power to propulsion source 105 and/or electric power inverter 115. Propulsion source 105 may be deactivated by ceasing to supply electric power to propulsion source 105 and/or electric power inverter 115. Still other examples may additionally or optionally use a start/stop button that is manually pressed by the operator to start or shut down the propulsion source 105 to turn the vehicle on or off. In other examples, a remote electrified axle or electric machine start may be initiated remote computing device (not shown), for example a cellular telephone, or smartphone-based system where a user's cellular telephone sends data to a server and the server communicates with the vehicle control unit 152 to activate the inverter 115 and propulsion source 105. Spatial orientation of vehicle 10 is indicated via axes 175.

Vehicle 10 is also shown with a foundation or friction caliper controller 170. Friction caliper controller 170 may selectively apply and release friction calibers (e.g., 172a and 172b) via allowing hydraulic fluid to flow to the friction calipers. The friction calipers may be applied and released so as to reduce locking of the friction calipers to front wheels 102 and rear wheels 103. Wheel position or speed sensors 161 may provide wheel speed data to friction caliper controller 170. Vehicle propulsion system 199 may provide torque to rear wheels 103 to propel vehicle 10.

A human or autonomous driver 142 may request a driver demand wheel torque, or alternatively a driver demand wheel power, via applying driver demand pedal 140 or via supplying a driver demand wheel torque/power request to vehicle control unit 152. Vehicle control unit 152 may then demand a torque or power from propulsion source 105 via commanding powertrain controller 116. Powertrain controller 116 may command electric power inverter 115 to deliver the driver demand wheel torque/power via electrified axle 190 and propulsion source 105. Electric power inverter 115 may convert DC electrical power from battery 160 into AC power and supply the AC power to propulsion source 105. Propulsion source 105 rotates and transfers torque/power to transmission 135. Transmission 135 may supply torque from propulsion source 105 to differential gears 106, and differential gears 106 transfer torque from propulsion source 105 to rear wheels 103 via axle shafts 190a and 190b.

During conditions when the driver demand pedal is fully released, vehicle control unit 152 may request a small negative or regenerative power to gradually slow vehicle 10 when a speed of vehicle 10 is greater than a threshold speed. The amount of regenerative power requested may be a function of driver demand pedal position, battery state of charge (SOC), vehicle speed, and other conditions. If the driver demand pedal 140 is fully released and vehicle speed is less than a threshold speed, vehicle control unit 152 may request a small amount of positive torque/power (e.g., propulsion torque) from propulsion source 105, which may be referred to as creep torque or power. The creep torque or power may allow vehicle 10 to remain stationary when vehicle 10 is on a small positive grade.

The human or autonomous driver may also request a negative or regenerative driver demand slowing torque, or alternatively a driver demand slowing power, via applying caliper pedal 150 or via supplying a driver demand slowing power request to vehicle control unit 152. Vehicle control unit 152 may request that a first portion of the driver demanded slowing power be generated via propulsion source 105 via commanding powertrain controller 116. Additionally, vehicle control unit 152 may request that a portion of the driver demanded slowing power be provided via friction calipers 172a and 172b via commanding friction caliper controller 170 to provide a second portion of the driver requested slowing power.

After vehicle control unit 152 determines the slowing power request, vehicle control unit 152 may command powertrain controller 116 to deliver the portion of the driver demand slowing power allocated to propulsion source 105. Propulsion source 105 may convert the vehicle's kinetic energy into AC power.

Powertrain controller 116 includes predetermined transmission gear shift schedules whereby fixed ratio gears of transmission 135 may be selectively engaged and disengaged. Shift schedules stored in powertrain controller 116 may select gear shift points or events as a function of driver demand wheel torque and vehicle speed.

The system of FIG. 1 provides for a system for operating an electric machine, comprising: a controller including executable instructions that cause the controller to generate a dq phase angle in response to a motor maximum torque per ampere angle and an inverter current angle, and generate direct current and quadrature current to operate the electric machine according to the dq phase angle. In a first example, the system includes where the inverter current angle is an angle of inverter current with respect to the start of the present cycle of the current output of the inverter for a particular phase leg of the inverter. In a second example that may include the first example, the system includes where the dq phase angle is generated during a second condition in response to the motor maximum torque per ampere angle and the inverter current angle, and further comprising generating the dq phase angle during a first condition in response to a sole angle. In a third example that may include one or both of the first and second examples, the system includes where the sole angle is the motor maximum torque per ampere angle. In a fourth example that may include one or more of the first through third examples, the system includes where the second condition is a rotational speed of the electric machine being less than a threshold rotational speed. In a fifth example that may include one or more of the first through fourth examples, the system includes where the dq phase angle is an angle between the direct current and the quadrature current of the electric machine. In a sixth example that may include one or more of the first through fifth examples, the system includes where the motor maximum torque per ampere angle is based on a maximum electric machine current.

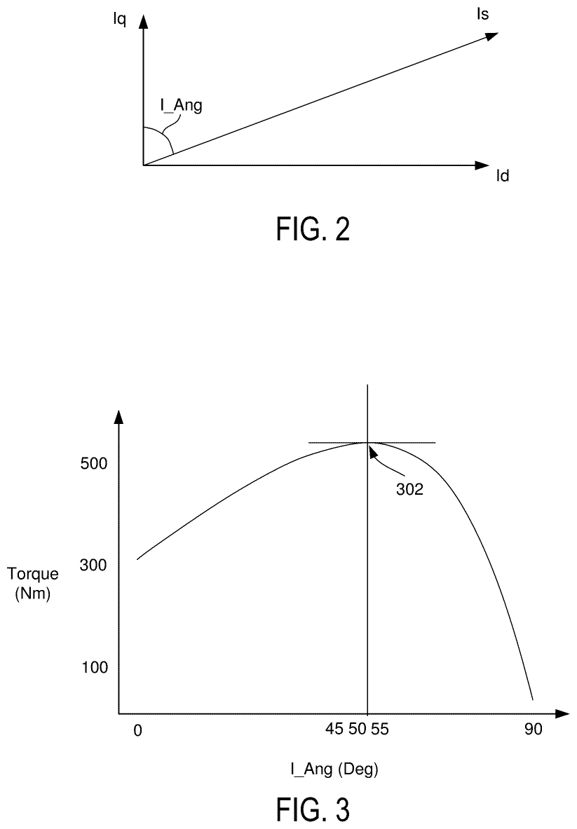

FIG. 2 illustrates a dq current angle with respect to a coordinate system defined by electric machine inductor quadrature current lq and electric machine inductor direct current ld. The quadrature current is torque generating current whereas the direct current is field generating current. The dq current phase angle (I_Ang) is indicated with respect to the lq and ld axes. The dq current phase angle (I_Ang) is based on lq and ld current vectors.

Regarding FIG. 3, it illustrates electric machine torque as a function of dq current angle (I_Ang). It may be observed that the electric machine torque increases from a dq current angle of zero to a dq current angle of about 52.5 degrees where electric machine torque reaches a maximum value. As the dq current angle increases above 52.5 degrees to 90 degrees, the electric machine torque declines. An analysis of FIG. 3 indicates that for a specific dq current angle (I_Ang), the ratio of electric machine output torque to electric machine current reaches a maximum. The maximum current that an inverter leg may provide may be constrained by a current or power capacity of its power switches in the inverter leg. Therefore, for any given dq current angle (I_Ang), torque becomes a function of inverter current angle. The motor maximum torque per ampere (MTPA) is indicated by arrow 302.

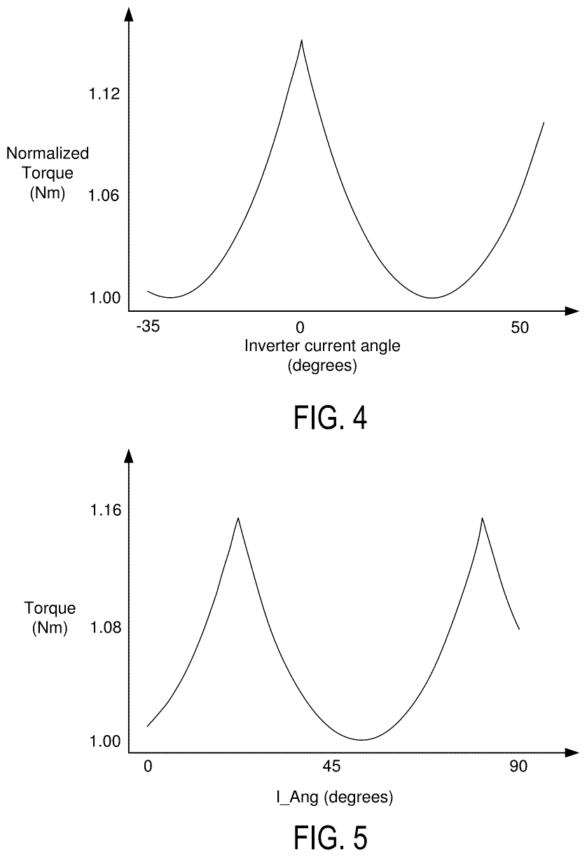

Turning now to FIG. 4, it demonstrates how inverter current angle influences zero rotational speed electric machine maximum torque output, which may be referred to as maximum torque per ampere (motor MTPA), assuming similar dq current angle values. In the example of FIG. 4, with an angle periodicity of 60 degrees, the normalized maximum torque may vary between 1 and 1.15, where normalized torque is electric machine torque divided by electric machine torque at zero speed at worst case.

The vertical axis of FIG. 4 represents normalized motor torque output. The horizontal axis of FIG. 4 represents inverter current angle in degrees. FIG. 4 shows how motor output torque varies with inverter current angle at zero rotational speed of the motor for a 3-phase motor or electric machine.

Referring now to FIG. 5, it shows the combined effect of inverter current angle and dq current (I_Ang) on electric machine output torque. FIG. 5 shows the inverter power switch capacity effect on zero-speed electric machine output torque as a function of I_Ang when there is a 30 degree difference between the motor MTPA angle and the inverter maximum torque angle for a 3-phase electric machine. There is an motor MTPA angle shift that maximizes output torque of the electric machine for any angle between the motor MTPA angle and the inverter maximum torque angle (e.g., the inverter current angle with respect to the start of the present cycle of current output of the inverter for a particular phase leg where a distribution of losses between the inverter's power switches is optimal such that a motor connected to the inverter generates a maximum torque for the motor at present motor operating conditions (e.g., speed and temperature)). Therefore, the present method adjusts I_Ang so that the electric machine outputs a maximum torque. The adjusted I_Ang is referred to as Gamma.

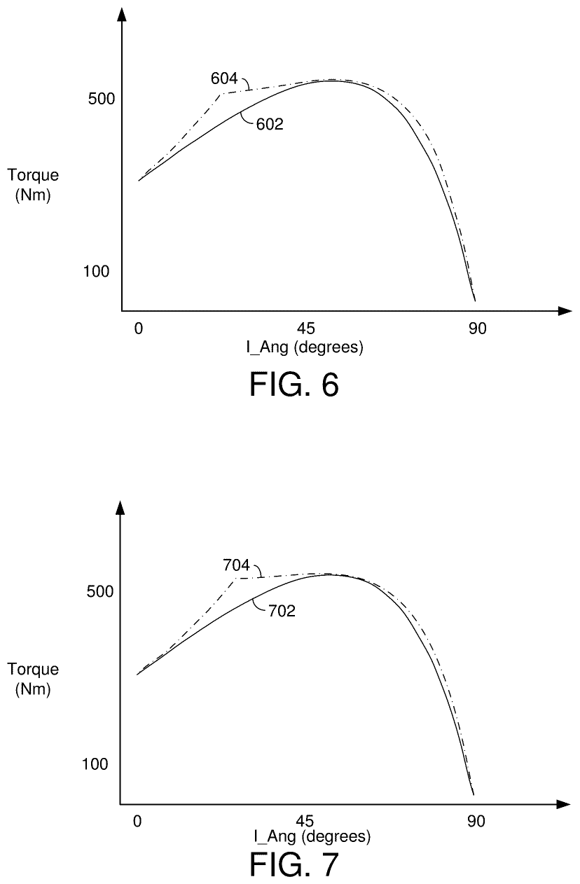

FIGS. 6-15 show electric machine torque comparisons for where dq current phase angle is determined solely based on, or determined solely from electric machine motor MTPA, and where dq current phase angle is determined from electric machine motor MTPA and inverter current angle. Each of the plots in FIGS. 6-15 is for a different angular distance between motor MTPA angle and inverter maximum torque angle.

FIG. 6 is a plot of electric machine torque verses dq current phase angle (I_Ang). The vertical axis represents electric machine torque in Newton-meters (N-m) and the horizontal axis represents dq current phase angle (I_Ang). Line 602 represents electric machine torque output for the electric machine at zero rotational speed for when there is 30 degrees between the motor MTPA angle and the inverter maximum torque angle, and where the dq current phase angle is determined solely based on, or determined solely from electric machine motor MTPA. Line 604 represents electric machine torque output for the electric machine at zero rotational speed for when there is 30 degrees between the motor MTPA angle and the inverter maximum torque angle, and where dq current phase angle is determined from electric machine motor MTPA and inverter current angle. The lines in FIG. 6 are generated with peak current of 450 amperes.

FIG. 7 is also a plot of electric machine torque verses dq current phase angle (I_Ang). The vertical axis represents electric machine torque in Newton-meters (N-m) and the horizontal axis represents dq current phase angle (I_Ang). Line 702 represents electric machine torque output for the electric machine at zero rotational speed for when there is 26 degrees between the motor MTPA angle and the inverter maximum torque angle, and where the dq current phase angle is determined solely based on, or determined solely from electric machine motor MTPA. Line 704 represents electric machine torque output for the electric machine at zero rotational speed for when there is 26 degrees between the motor MTPA angle and the inverter maximum torque angle, and where dq current phase angle is determined from electric machine motor MTPA and inverter current angle. The lines in FIG. 7 are generated with peak current of 450 amperes.

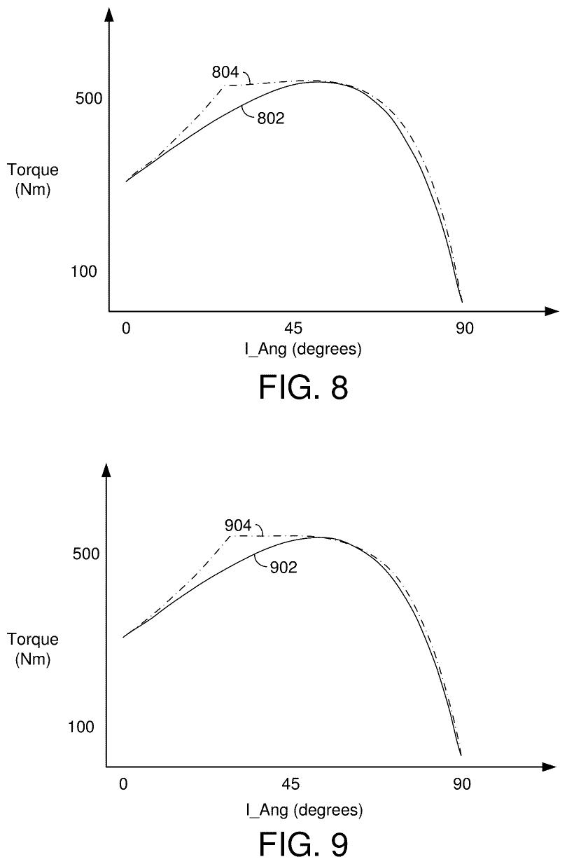

FIG. 8 is a plot of electric machine torque verses dq current phase angle (I_Ang). The vertical axis represents electric machine torque in Newton-meters (N-m) and the horizontal axis represents dq current phase angle (I_Ang). Line 802 represents electric machine torque output for the electric machine at zero rotational speed for when there is 25 degrees between the motor MTPA angle and the inverter maximum torque angle, and where the dq current phase angle is determined solely based on, or determined solely from electric machine motor MTPA. Line 804 represents electric machine torque output for the electric machine at zero rotational speed for when there is 25 degrees between the motor MTPA angle and the inverter maximum torque angle, and where dq current phase angle is determined from electric machine motor MTPA and inverter current angle. The lines in FIG. 8 are generated with peak current of 450 amperes.

FIG. 9 is a plot of electric machine torque verses dq current phase angle (I_Ang). The vertical axis represents electric machine torque in Newton-meters (N-m) and the horizontal axis represents dq current phase angle (I_Ang). Line 902 represents electric machine torque output for the electric machine at zero rotational speed for when there is 24 degrees between the motor MTPA angle and the inverter maximum torque angle, and where the dq current phase angle is determined solely based on, or determined solely from electric machine motor MTPA. Line 904 represents electric machine torque output for the electric machine at zero rotational speed for when there is 24 degrees between the motor MTPA angle and the inverter maximum torque angle, and where dq current phase angle is determined from electric machine motor MTPA and inverter current angle. The lines in FIG. 9 are generated with peak current of 450 amperes.

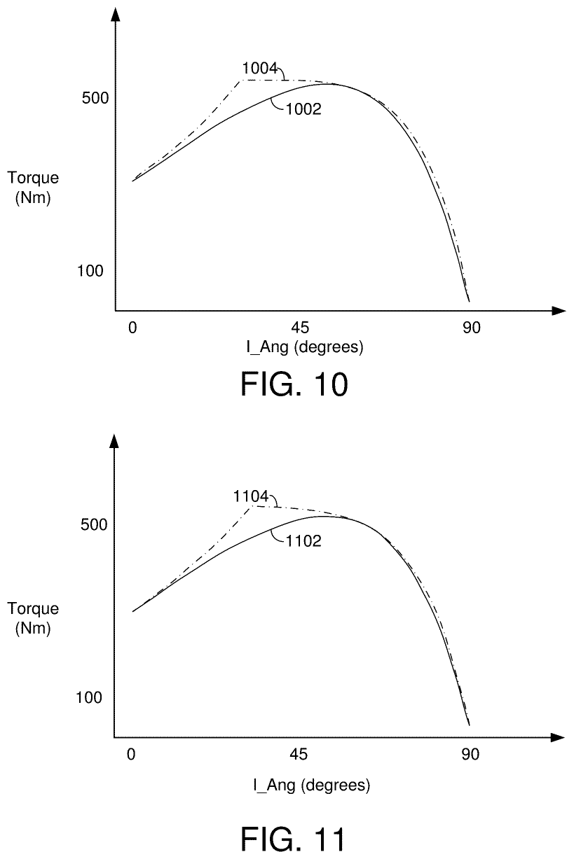

FIG. 10 is a plot of electric machine torque verses dq current phase angle (I_Ang). The vertical axis represents electric machine torque in Newton-meters (N-m) and the horizontal axis represents dq current phase angle (I_Ang). Line 1002 represents electric machine torque output for the electric machine at zero rotational speed for when there is 23 degrees between the motor MTPA angle and the inverter maximum torque angle, and where the dq current phase angle is determined solely based on, or determined solely from electric machine motor MTPA. Line 1004 represents electric machine torque output for the electric machine at zero rotational speed for when there is 23 degrees between the motor MTPA angle and the inverter maximum torque angle, and where dq current phase angle is determined from electric machine motor MTPA and inverter current angle. The lines in FIG. 10 are generated with peak current of 450 amperes.

FIG. 11 is a plot of electric machine torque verses dq current phase angle (I_Ang). The vertical axis represents electric machine torque in Newton-meters (N-m) and the horizontal axis represents dq current phase angle (I_Ang). Line 1102 represents electric machine torque output for the electric machine at zero rotational speed for when there is 20 degrees between the motor MTPA angle and the inverter maximum torque angle, and where the dq current phase angle is determined solely based on, or determined solely from electric machine motor MTPA. Line 1104 represents electric machine torque output for the electric machine at zero rotational speed for when there is 20 degrees between the motor MTPA angle and the inverter maximum torque angle, and where dq current phase angle is determined from electric machine motor MTPA and inverter current angle. The lines in FIG. 11 are generated with peak current of 450 amperes.

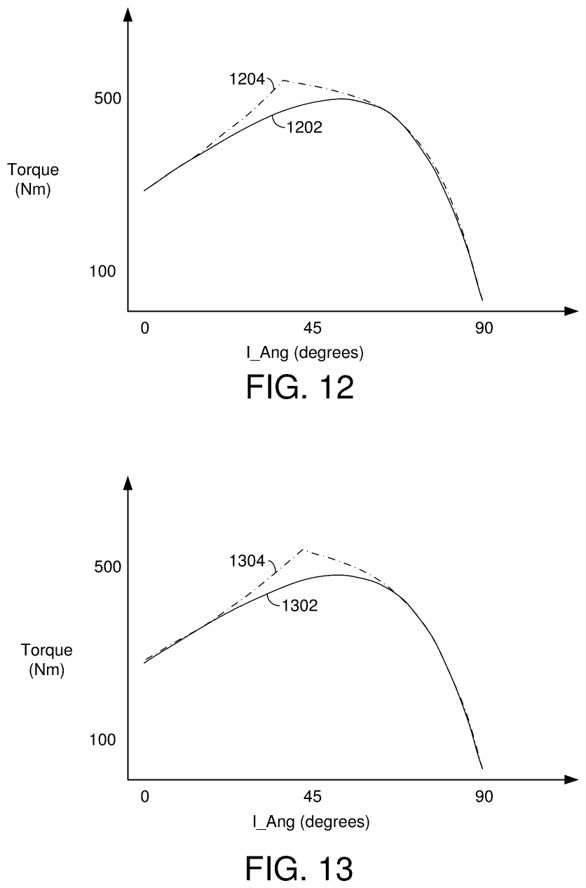

FIG. 12 is a plot of electric machine torque verses dq current phase angle (I_Ang). The vertical axis represents electric machine torque in Newton-meters (N-m) and the horizontal axis represents dq current phase angle (I_Ang). Line 1202 represents electric machine torque output for the electric machine at zero rotational speed for when there is 15 degrees between the motor MTPA angle and the inverter maximum torque angle, and where the dq current phase angle is determined solely based on, or determined solely from electric machine motor MTPA. Line 1204 represents electric machine torque output for the electric machine at zero rotational speed for when there is 15 degrees between the motor MTPA angle and the inverter maximum torque angle, and where dq current phase angle is determined from electric machine motor MTPA and inverter current angle. The lines in FIG. 12 are generated with peak current of 450 amperes.

FIG. 13 is a plot of electric machine torque verses dq current phase angle (I_Ang). The vertical axis represents electric machine torque in Newton-meters (N-m) and the horizontal axis represents dq current phase angle (I_Ang). Line 1302 represents electric machine torque output for the electric machine at zero rotational speed for when there is 10 degrees between the motor MTPA angle and the inverter maximum torque angle, and where the dq current phase angle is determined solely based on, or determined solely from electric machine motor MTPA. Line 1304 represents electric machine torque output for the electric machine at zero rotational speed for when there is 10 degrees between the motor MTPA angle and the inverter maximum torque angle, and where dq current phase angle is determined from electric machine motor MTPA and inverter current angle. The lines in FIG. 13 are generated with peak current of 450 amperes.

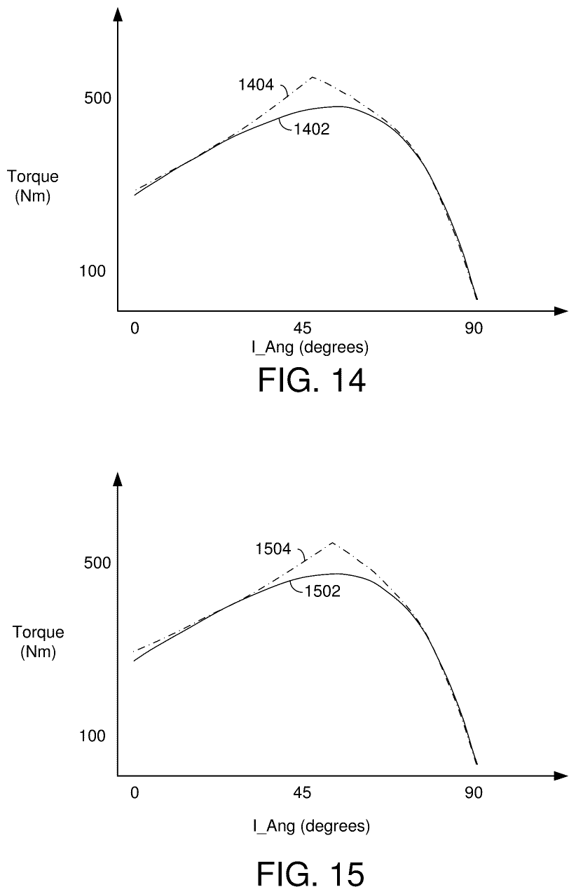

FIG. 14 is a plot of electric machine torque verses dq current phase angle (I_Ang). The vertical axis represents electric machine torque in Newton-meters (N-m) and the horizontal axis represents dq current phase angle (I_Ang). Line 1402 represents electric machine torque output for the electric machine at zero rotational speed for when there is 5 degrees between the motor MTPA angle and the inverter maximum torque angle, and where the dq current phase angle is determined solely based on, or determined solely from electric machine motor MTPA. Line 1404 represents electric machine torque output for the electric machine at zero rotational speed for when there is 5 degrees between the motor MTPA angle and the inverter maximum torque angle, and where dq current phase angle is determined from electric machine motor MTPA and inverter current angle. The lines in FIG. 14 are generated with peak current of 450 amperes.

FIG. 15 is a plot of electric machine torque verses dq current phase angle (I_Ang). The vertical axis represents electric machine torque in Newton-meters (N-m) and the horizontal axis represents dq current phase angle (I_Ang). Line 1502 represents electric machine torque output for the electric machine at zero rotational speed for when there is 0 degrees between the motor MTPA angle and the inverter maximum torque angle, and where the dq current phase angle is determined solely based on, or determined solely from electric machine motor MTPA. Line 1504 represents electric machine torque output for the electric machine at zero rotational speed for when there is 0 degrees between the motor MTPA angle and the inverter maximum torque angle, and where dq current phase angle is determined from electric machine motor MTPA and inverter current angle. The lines in FIG. 15 are generated with peak current of 450 amperes.

Table 1 shown below illustrates maximum (max.) motor output torque and its corresponding I_Ang (gamma angle) for FIGS. 6-15.

TABLE 1

| | Difference between | | |
|---|---|---|---|
| | MTPA angle and | I_Ang for max. | |
| FIG. | inverter max. torque | torque (gamma | Max. |
| number | angle (degrees) | angle) (degrees) | torque (N-m) |
| 6 | 30 | 52 | 538 |
| 7 | 26 | 48 | 541 |
| 8 | 25 | 46 | 542 |
| 9 | 24 | 43 | 544 |
| 10 | 23 | 29 | 548 |
| 11 | 20 | 32 | 563 |
| 12 | 15 | 37 | 586 |
| 13 | 10 | 42 | 604 |
| 14 | 5 | 47 | 617 |
| 15 | 0 | 52 | 621 |

Referring now to FIG. 16, a block diagram 1600 of a method for determining maximum torque output of an electric machine, its related dq current phase angle (I_Ang), and a corresponding angle between motor MTPA angle and the inverter's maximum torque angle is shown. The method of block diagram 1600 may be stored as executable instructions in non-transitory memory of one or more controllers. Method 1600 may operate in coordination with the system of FIG. 1 to determine maximum torque output of an electric machine, its related dq current phase angle (I_Ang), and a corresponding angle between motor MTPA angle and the inverter's maximum torque angle. The control parameters determined in the method of FIG. 16 may be applied to a controller to control electric machine torque at zero and lower electric machine rotational speeds.

At 1602, method 1600 references a table or function that outputs a maximum motor torque per ampere angle at a present electric machine rotational speed (I_Angₘₐₓ₀) according to the target torque and the maximum electric current. The table or function may be populated with I_Angₘₐₓ₀ values that are based on plots or functions as shown in FIG. 3. Block 1602 outputs the I_Angmₐₓ₀ angle to block 1606.

At 1604, method 1600 outputs a value θ0 that may vary between −30 degrees and 30 degrees for 3 phase or 6 phase symmetrical machines. Also, it may vary between −15degrees to 15 degrees a 6 phase asymmetrical machine. the θ0value may vary based on the required accuracy for calculating the “I_Ang for maximum torque” and the curvature of the torque map in FIG. 3. For example, with a flat torque curve, a θ0 step of 1 degree may be applied. Conversely, for a non-flat torque curve, a smaller step size for example 0.5 degree may be preferred. It's important to note that decreasing the θ0 step size increases the accuracy of the “I_Ang for maximum torque” calculation but increases the calculation time.

At 1606, method 1600 subtracts the output of block 1602 from the output of block 1604. The result is passed to summing junction 1608.

At 1610, method 1600 changes or varies the I_Ang value from a minimum value to a maximum value. In one example, the value of I_Ang may be varied from a value of 0 to 90 degrees as shown in FIG. 3. Block 1610 outputs the value of I_Ang to block 1608 and block 1630.

At 1608, method 1600 adds the output of block 1610 from the output of block 1606. The resulting angle θ is passed to block 1612.

At 1612, method 1600 determines a maximum value from three values. The three values are sin (θ), sin (θ−2π/3), and sin (θ+2π/3) according to the θ input value from block 1608.

At 1614, method 1600 method 1600 determines the result of one divided by the output of block 1612 (c.g., the multiplicative inverse). Method 1600 outputs the result to block 1616.

At 1630, method 1600 receives the I_Ang value and outputs a torque value according to a torque map (e.g., see FIG. 3). The torque value is input to block 1616.

At 1616, method 1600 multiplies the output of block 1614 with the output of block 1630 and the result is output to block 1618.

At 1618, method 1600 compares the output of block 1616 to the output of block 1620 and it outputs a maximum value of those to values to block 1622.

At 1620, method 1600 stores a most recent output of block 1618 for one execution cycle of method 1600. Thus, the output of block 1620 is the output of block 1618 delayed by one execution cycle of method 1600.

At 1622, method 1600 determines maximum torque values based on I_Ang input values from block 1618. Method 1600 may apply a torque map similar to the plot shown in FIG. 3, but method 1600 doesn't directly use I_Ang values. Rather, it applies specific I_Ang values that maximize the output of block 1616. The torque map outputs torque values corresponding to these chosen I_Ang values.

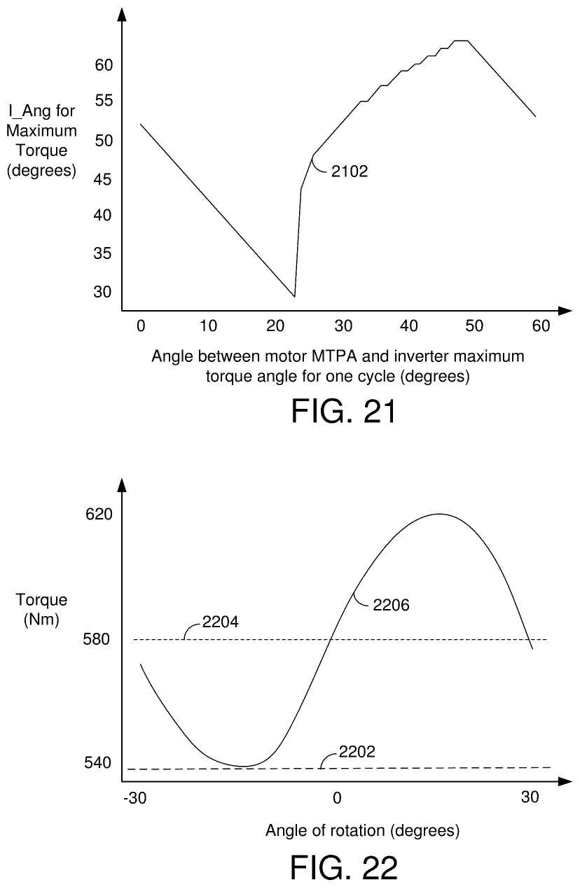

At 1624, method 1600 saves maximum torque values that are output from block 1622 and their related I_Ang values. Block 1624 also saves the gap or angle between the MTPA angle and the inverter maximum torque angle. These stored values may be applied to generate the graphs or functions relating I_Ang to torque (e.g., the relationships shown in FIGS. 21, 24, etc.).

FIGS. 17-36 show output of the method of FIG. 16 for the same motor that is the basis for FIGS. 6-15. The illustrated output is for different motor angles between the motor MTPA angle and the maximum motor torque angle at zero rotational motor speed. The figures show that determining the dq phase angle based on both motor MTPA angle and inverter current angle yields higher electric machine torque output than does determining the dq phase angle based solely on motor MTPA angle. Thus, determining dq phase angle based on both motor MTPA angle and inverter current angle yields higher electric machine torque outputs at lower electric machine rotational speeds. Thus, when the electric machine is operated based on dq phase angle that is generated from both motor MTPA and inverter current angle, a greater amount of torque may be generated even if electric machine current is constrained to reduce a possibility of inverter switch degradation.

Referring now to FIG. 17, a plot of electric machine torque (Newton-meters (N-m)) verses electric machine rotational angle (degrees) when there is 0 Deg difference between the MPTA angle and the inverter maximum torque angle at zero angle of rotation is shown. The vertical axis represents electric machine torque in Newton-meters (N-m) and the horizontal axis represents electric machine angle of rotation in degrees. The operating conditions of this plot are that there are zero angular degrees between the motor MTPA angle and the inverter maximum torque angle at zero angular degrees of electric machine rotation.

Line 1702 represents electric machine torque output for the electric machine at zero rotational speed for when the electric machine is operated based on a dq phase angle that is generated solely from motor MTPA angle. Line 1704 represents average electric machine torque output for the electric machine at zero rotational speed for when the electric machine is operated based on a dq phase angle that is generated from both the motor MTPA angle and the inverter current angle. Line 1706 represents electric machine torque output for the electric machine at zero rotational speed for when the electric machine is operated based on a dq phase angle that is generated from both the motor MTPA angle and the inverter current angle.

Thus, at the operating conditions of FIG. 17, the electric machine may generate significantly more torque when the electric machine is operated according to a dq phase angle that is generated from both the motor MTPA angle and the inverter current angle. This allows the electric machine to generate additional torque for a given amount of electric machine current.

Referring now to FIG. 18, a plot of electric machine dq phase angle (I_Ang) for maximum electric machine torque verses electric machine rotational angle (degrees). The vertical axis represents electric machine dq phase angle (I_Ang) in degrees for maximum electric machine torque and the horizontal axis represents electric machine angle of rotation in degrees. The operating conditions of this plot are that there are zero angular degrees between the motor MTPA angle and the inverter maximum torque angle at zero angular degrees of electric machine rotation.

Line 1802 represents electric machine dq phase angle for maximum electric machine torque at zero rotational speed for when there are zero degrees of difference between the motor MTPA angle and the inverter maximum torque angle when the dq phase angle is based solely on the motor MTPA angle. Line 1804 represents electric machine dq phase angle for maximum electric machine torque at zero rotational speed for when there are zero degrees of difference between the motor MTPA angle and the inverter maximum torque angle where the dq phase angle is generated from both the motor MTPA angle and the inverter current angle.

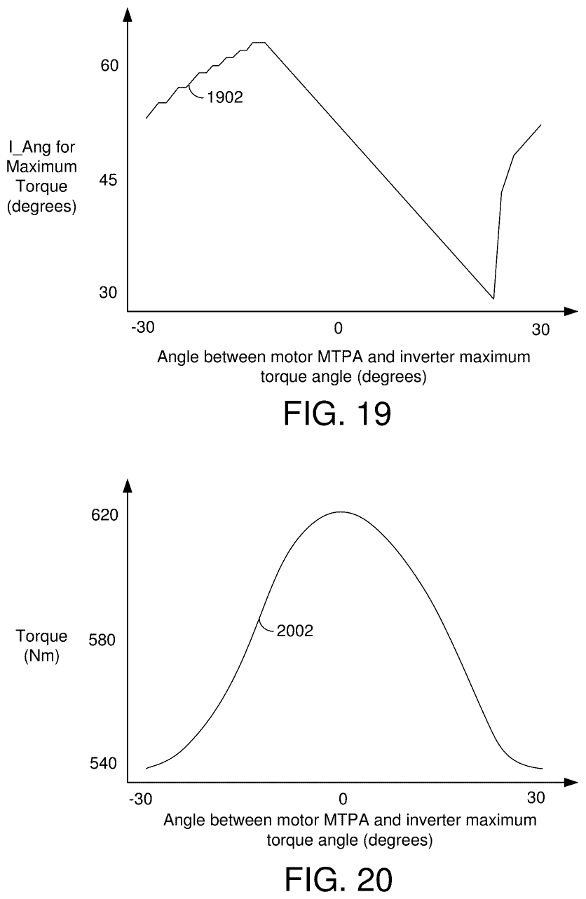

Referring now to FIG. 19, a plot of electric machine dq phase angle (I_Ang) for maximum electric machine torque verses angle between motor MTPA and inverter maximum torque angle (degrees). The vertical axis represents electric machine dq phase angle (I_Ang) for maximum electric machine torque in degrees and the horizontal axis represents the angle between motor MTPA and inverter maximum torque angle. The operating conditions of this plot are that there are zero angular degrees between the motor MTPA angle and the inverter maximum torque angle at zero angular degrees of electric machine rotation.

Line 1902 represents a relationship between electric machine dq phase angle for maximum electric machine torque output and the angle between motor MTPA and inverter maximum torque angle when there are zero degrees of difference between the motor MTPA angle and the inverter maximum torque angle at zero rotational electric machine speed.

Referring now to FIG. 20, a plot of electric machine torque output verses the angle between motor MTPA and inverter maximum torque angle (degrees). The vertical axis represents electric machine torque output in Newton-meters (N-m) and the horizontal axis represents the angle between motor MTPA and inverter maximum torque angle. The operating conditions of this plot are that there are zero angular degrees between the motor MTPA angle and the inverter maximum torque angle at zero angular degrees of electric machine rotation.

Line 2002 represents a relationship between electric machine torque output and the angle between motor MTPA and inverter maximum torque angle when there are zero degrees of difference between the motor MTPA angle and the inverter maximum torque angle at zero rotational electric machine speed.

Referring now to FIG. 21, a plot of electric machine dq phase angle (I_Ang) for maximum electric machine torque verses angle between motor MTPA and inverter maximum torque angle (degrees) for one electric cycle of the machine. The vertical axis represents electric machine dq phase angle (I_Ang) for maximum electric machine torque in degrees and the horizontal axis represents the angle between motor MTPA and inverter maximum torque angle for one electric cycle of the machine. The operating conditions of this plot are that there are fifteen angular degrees between the motor MTPA angle and the inverter maximum torque angle at zero angular degrees of electric machine rotation.

Line 2102 represents a relationship between electric machine dq phase angle for maximum electric machine torque output and the angle between motor MTPA and inverter maximum torque angle for one cycle when there are fifteen degrees of difference between the motor MTPA angle and the inverter maximum torque angle at zero rotational electric machine speed.

Referring now to FIG. 22, a plot of electric machine torque (Newton-meters (N-m)) verses electric machine rotational angle (degrees) is shown. The vertical axis represents electric machine torque in Newton-meters (N-m) and the horizontal axis represents electric machine angle of rotation in degrees. The operating conditions of this plot are that there are 15 angular degrees between the motor MTPA angle and the inverter maximum torque angle at zero angular degrees of electric machine rotation.

Line 2202 represents electric machine torque output for the electric machine at zero rotational speed for when the electric machine is operated based on a dq phase angle that is generated solely from motor MTPA angle. Line 2204 represents average electric machine torque output for the electric machine at zero rotational speed for when the electric machine is operated based on a dq phase angle that is generated from both the motor MTPA angle and the inverter current angle. Line 2206 represents electric machine torque output for the electric machine at zero rotational speed for when the electric machine is operated based on a dq phase angle that is generated from both the motor MTPA angle and the inverter current angle.

Thus, at the operating conditions of FIG. 22, the electric machine may generate significantly more torque when the electric machine is operated according to a dq phase angle that is generated from both the motor MTPA angle and the inverter current angle. This allows the electric machine to generate additional torque for a given amount of electric machine current when there is 15 angular degrees between the motor MTPA angle and the inverter maximum torque angle.

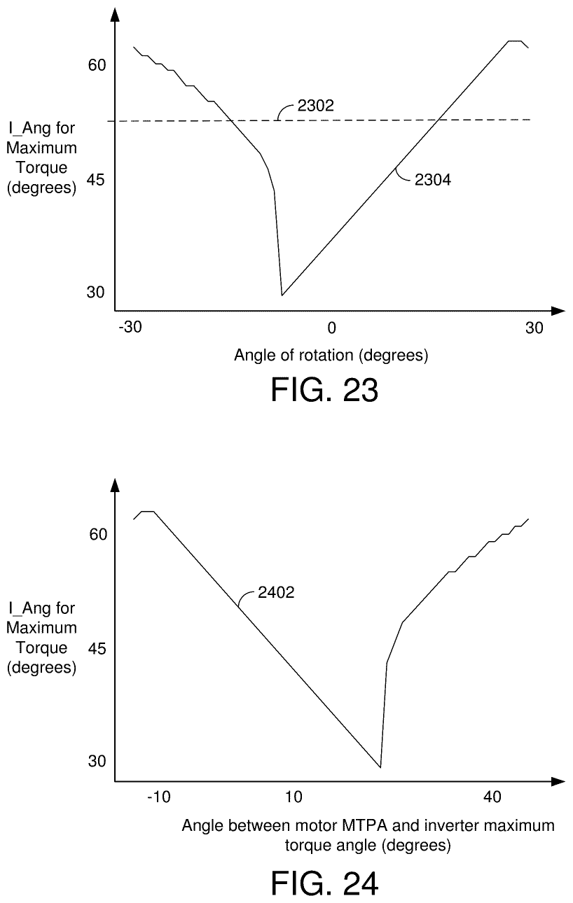

Referring now to FIG. 23, a plot of electric machine dq phase angle (I_Ang) for maximum electric machine torque verses electric machine rotational angle (degrees). The vertical axis represents electric machine dq phase angle (I_Ang) in degrees for maximum electric machine torque and the horizontal axis represents electric machine angle of rotation in degrees. The operating conditions of this plot are that there are 15 angular degrees between the motor MTPA angle and the inverter maximum torque angle at zero angular degrees of electric machine rotation.

Line 2302 represents electric machine dq phase angle for maximum electric machine torque at zero rotational speed for when there are 15 degrees of difference between the motor MTPA angle and the inverter maximum torque angle when the dq phase angle is based solely on the motor MTPA angle. Line 2304 represents electric machine dq phase angle for maximum electric machine torque at zero rotational speed for when there are 15 degrees of difference between the motor MTPA angle and the inverter maximum torque angle where the dq phase angle is generated from both the motor MTPA angle and the inverter current angle.

Referring now to FIG. 24, a plot of electric machine dq phase angle (I_Ang) for maximum electric machine torque verses angle between motor MTPA and inverter maximum torque angle (degrees). The vertical axis represents electric machine dq phase angle (I_Ang) for maximum electric machine torque in degrees and the horizontal axis represents the angle between motor MTPA and inverter maximum torque angle for one electric cycle of the machine. The operating conditions of this plot are that there are 15 angular degrees between the motor MTPA angle and the inverter maximum torque angle at zero angular degrees of electric machine rotation.

Line 2402 represents a relationship between electric machine dq phase angle for maximum electric machine torque output and the angle between motor MTPA and inverter maximum torque angle for one cycle when there are 15 degrees of difference between the motor MTPA angle and the inverter maximum torque angle at zero rotational electric machine speed.

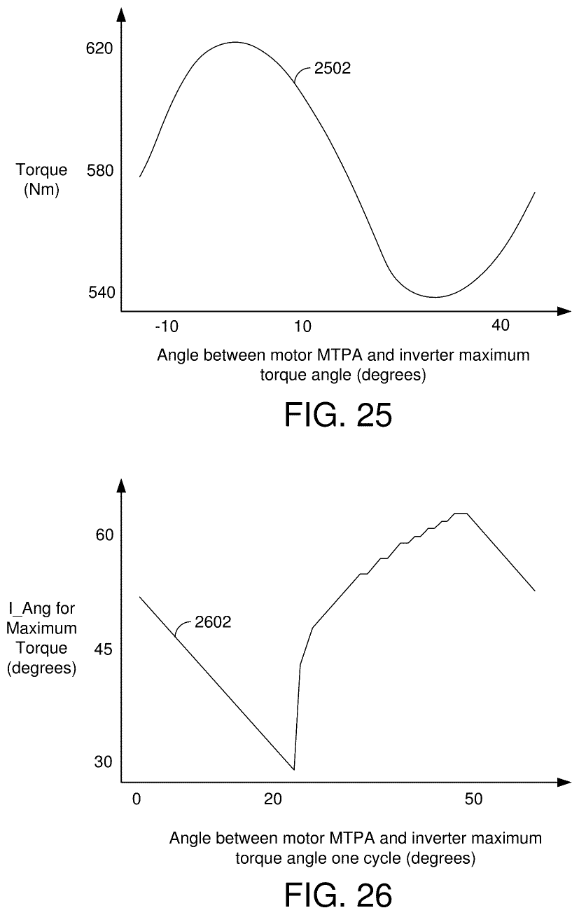

Referring now to FIG. 25, a plot of electric machine torque output verses the angle between motor MTPA and inverter maximum torque angle (degrees). The vertical axis represents electric machine torque output in Newton-meters (N-m) and the horizontal axis represents the angle between motor MTPA and inverter maximum torque angle. The operating conditions of this plot are that there are 15 angular degrees between the motor MTPA angle and the inverter maximum torque angle at zero angular degrees of electric machine rotation.

Line 2502 represents a relationship between electric machine torque output and the angle between motor MTPA and inverter maximum torque angle when there are 15 degrees of difference between the motor MTPA angle and the inverter maximum torque angle at zero rotational electric machine speed.

Referring now to FIG. 26, a plot of electric machine dq phase angle (I_Ang) for maximum electric machine torque verses angle between motor MTPA and inverter maximum torque angle (degrees) for one electric cycle of the machine. The vertical axis represents electric machine dq phase angle (I_Ang) for maximum electric machine torque in degrees and the horizontal axis represents the angle between motor MTPA and inverter maximum torque angle for one electric cycle of the machine. The operating conditions of this plot are that there are 15 angular degrees between the motor MTPA angle and the inverter maximum torque angle at zero angular degrees of electric machine rotation.

Line 2602 represents a relationship between electric machine dq phase angle for maximum electric machine torque output and the angle between motor MTPA and inverter maximum torque angle for one cycle when there are 15 degrees of difference between the motor MTPA angle and the inverter maximum torque angle at zero rotational electric machine speed.

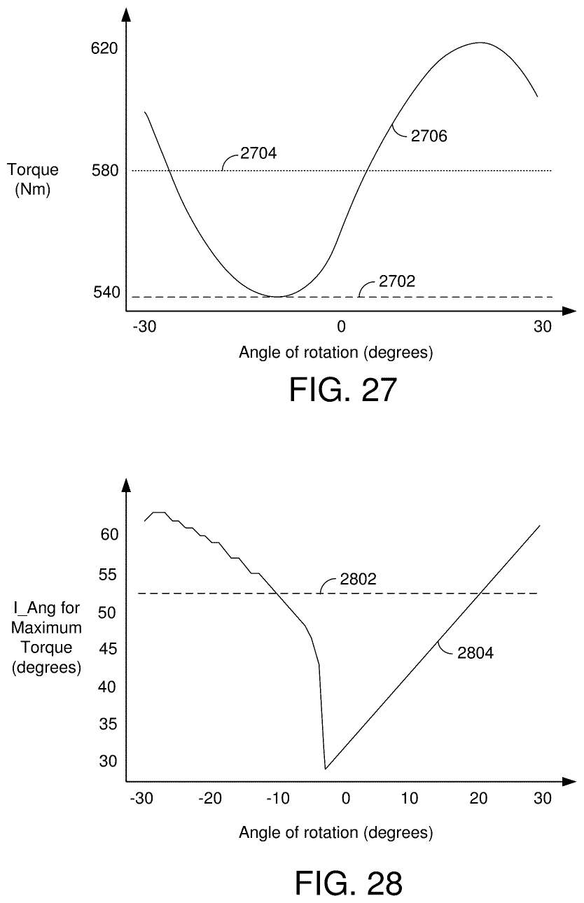

Referring now to FIG. 27, a plot of electric machine torque (Newton-meters (N-m)) verses electric machine rotational angle (degrees) is shown. The vertical axis represents electric machine torque in Newton-meters (N-m) and the horizontal axis represents electric machine angle of rotation in degrees. The operating conditions of this plot are that there are 20 angular degrees between the motor MTPA angle and the inverter maximum torque angle at zero angular degrees of electric machine rotation.

Line 2702 represents electric machine torque output for the electric machine at zero rotational speed for when the electric machine is operated based on a dq phase angle that is generated solely from motor MTPA angle. Line 2704 represents average electric machine torque output for the electric machine at zero rotational speed for when the electric machine is operated based on a dq phase angle that is generated from both the motor MTPA angle and the inverter current angle. Line 2706 represents electric machine torque output for the electric machine at zero rotational speed for when the electric machine is operated based on a dq phase angle that is generated from both the motor MTPA angle and the inverter current angle.

Thus, at the operating conditions of FIG. 27, the electric machine may generate significantly more torque when the electric machine is operated according to a dq phase angle that is generated from both the motor MTPA angle and the inverter current angle. This allows the electric machine to generate additional torque for a given amount of electric machine current when there is 20 angular degrees between the motor MTPA angle and the inverter maximum torque angle.

Referring now to FIG. 28, a plot of electric machine dq phase angle (I_Ang) for maximum electric machine torque verses electric machine rotational angle (degrees). The vertical axis represents electric machine dq phase angle (I_Ang) in degrees for maximum electric machine torque and the horizontal axis represents electric machine angle of rotation in degrees. The operating conditions of this plot are that there are 20 angular degrees between the motor MTPA angle and the inverter maximum torque angle at zero angular degrees of electric machine rotation.

Line 2802 represents electric machine dq phase angle for maximum electric machine torque at zero rotational speed for when there are 20 degrees of difference between the motor MTPA angle and the inverter maximum torque angle when the dq phase angle is based solely on the motor MTPA angle. Line 2804 represents electric machine dq phase angle for maximum electric machine torque at zero rotational speed for when there are 20 degrees of difference between the motor MTPA angle and the inverter maximum torque angle where the dq phase angle is generated from both the motor MTPA angle and the inverter current angle.

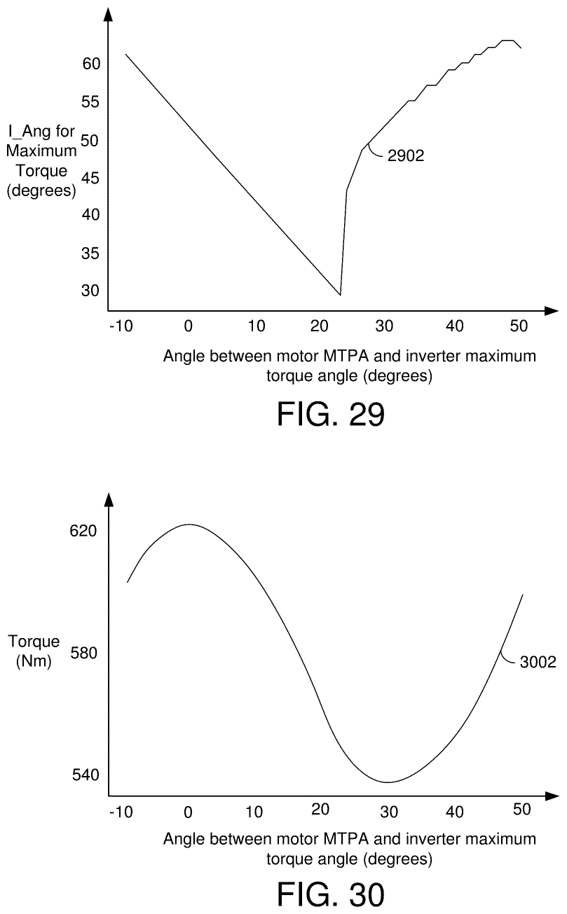

Referring now to FIG. 29, a plot of electric machine dq phase angle (I_Ang) for maximum electric machine torque verses angle between motor MTPA and inverter maximum torque angle (degrees). The vertical axis represents electric machine dq phase angle (I_Ang) for maximum electric machine torque in degrees and the horizontal axis represents the angle between motor MTPA and inverter maximum torque angle for one electric cycle of the machine. The operating conditions of this plot are that there are 20 angular degrees between the motor MTPA angle and the inverter maximum torque angle at zero angular degrees of electric machine rotation.

Line 2902 represents a relationship between electric machine dq phase angle for maximum electric machine torque output and the angle between motor MTPA and inverter maximum torque angle for one cycle when there are 20 degrees of difference between the motor MTPA angle and the inverter maximum torque angle at zero rotational electric machine speed.

Referring now to FIG. 30, a plot of electric machine torque output verses the angle between motor MTPA and inverter maximum torque angle (degrees). The vertical axis represents electric machine torque output in Newton-meters (N-m) and the horizontal axis represents the angle between motor MTPA and inverter maximum torque angle. The operating conditions of this plot are that there are 20 angular degrees between the motor MTPA angle and the inverter maximum torque angle at zero angular degrees of electric machine rotation.

Line 3002 represents a relationship between electric machine torque output and the angle between motor MTPA and inverter maximum torque angle when there are 20 degrees of difference between the motor MTPA angle and the inverter maximum torque angle at zero rotational electric machine speed.

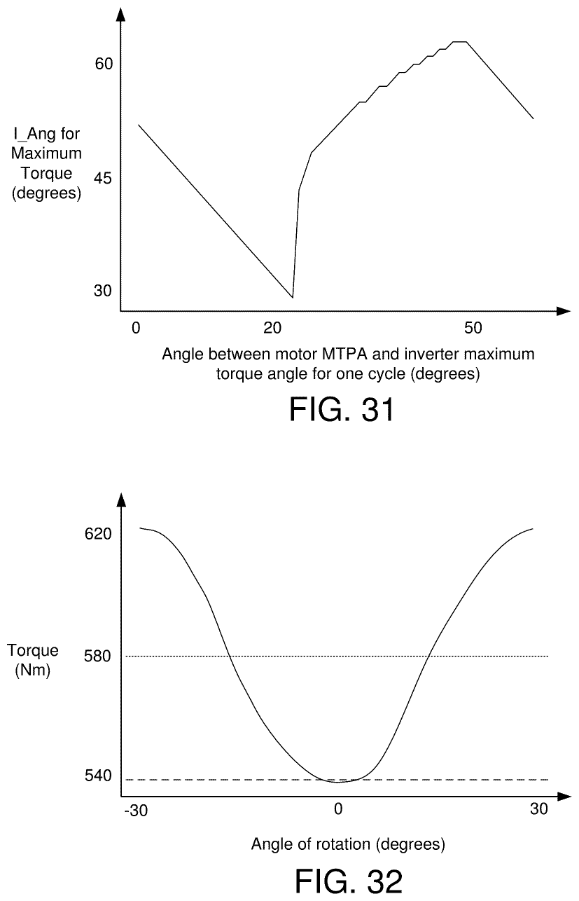

Referring now to FIG. 31, a plot of electric machine dq phase angle (I_Ang) for maximum electric machine torque verses angle between motor MTPA and inverter maximum torque angle (degrees) for one electric cycle of the machine. The vertical axis represents electric machine dq phase angle (I_Ang) for maximum electric machine torque in degrees and the horizontal axis represents the angle between motor MTPA and inverter maximum torque angle for one electric cycle of the machine. The operating conditions of this plot are that there are 20 angular degrees between the motor MTPA angle and the inverter maximum torque angle at zero angular degrees of electric machine rotation.

Line 3102 represents a relationship between electric machine dq phase angle for maximum electric machine torque output and the angle between motor MTPA and inverter maximum torque angle for one cycle when there are 20 degrees of difference between the motor MTPA angle and the inverter maximum torque angle at zero rotational electric machine speed.

Referring now to FIG. 32, a plot of electric machine torque (Newton-meters (N-m)) verses electric machine rotational angle (degrees) is shown. The vertical axis represents electric machine torque in Newton-meters (N-m) and the horizontal axis represents electric machine angle of rotation in degrees. The operating conditions of this plot are that there are 30 angular degrees between the motor MTPA angle and the inverter maximum torque angle at zero angular degrees of electric machine rotation.

Line 3202 represents electric machine torque output for the electric machine at zero rotational speed for when the electric machine is operated based on a dq phase angle that is generated solely from motor MTPA angle. Line 3204 represents average electric machine torque output for the electric machine at zero rotational speed for when the electric machine is operated based on a dq phase angle that is generated from both the motor MTPA angle and the inverter current angle. Line 3206 represents electric machine torque output for the electric machine at zero rotational speed for when the electric machine is operated based on a dq phase angle that is generated from both the motor MTPA angle and the inverter current angle.

Thus, at the operating conditions of FIG. 32, the electric machine may generate significantly more torque when the electric machine is operated according to a dq phase angle that is generated from both the motor MTPA angle and the inverter current angle. This allows the electric machine to generate additional torque for a given amount of electric machine current when there is 30 angular degrees between the motor MTPA angle and the inverter maximum torque angle.

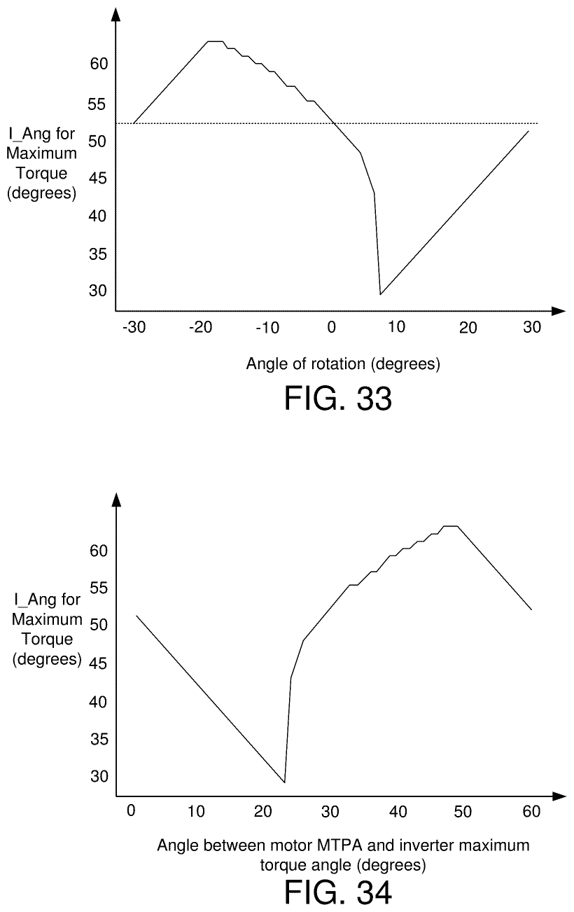

Referring now to FIG. 33, a plot of electric machine dq phase angle (I_Ang) for maximum electric machine torque verses electric machine rotational angle (degrees). The vertical axis represents electric machine dq phase angle (I_Ang) in degrees for maximum electric machine torque and the horizontal axis represents electric machine angle of rotation in degrees. The operating conditions of this plot are that there are 30 angular degrees between the motor MTPA angle and the inverter maximum torque angle at zero angular degrees of electric machine rotation.

Line 3302 represents electric machine dq phase angle for maximum electric machine torque at zero rotational speed for when there are 30 degrees of difference between the motor MTPA angle and the inverter maximum torque angle when the dq phase angle is based solely on the motor MTPA angle. Line 3304 represents electric machine dq phase angle for maximum electric machine torque at zero rotational speed for when there are 30 degrees of difference between the motor MTPA angle and the inverter maximum torque angle where the dq phase angle is generated from both the motor MTPA angle and the inverter current angle.

Referring now to FIG. 34, a plot of electric machine dq phase angle (I_Ang) for maximum electric machine torque verses angle between motor MTPA and inverter maximum torque angle (degrees). The vertical axis represents electric machine dq phase angle (I_Ang) for maximum electric machine torque in degrees and the horizontal axis represents the angle between motor MTPA and inverter maximum torque angle for one electric cycle of the machine. The operating conditions of this plot are that there are 30 angular degrees between the motor MTPA angle and the inverter maximum torque angle at zero angular degrees of electric machine rotation.

Line 3402 represents a relationship between electric machine dq phase angle for maximum electric machine torque output and the angle between motor MTPA and inverter maximum torque angle for one cycle when there are 30 degrees of difference between the motor MTPA angle and the inverter maximum torque angle at zero rotational electric machine speed.

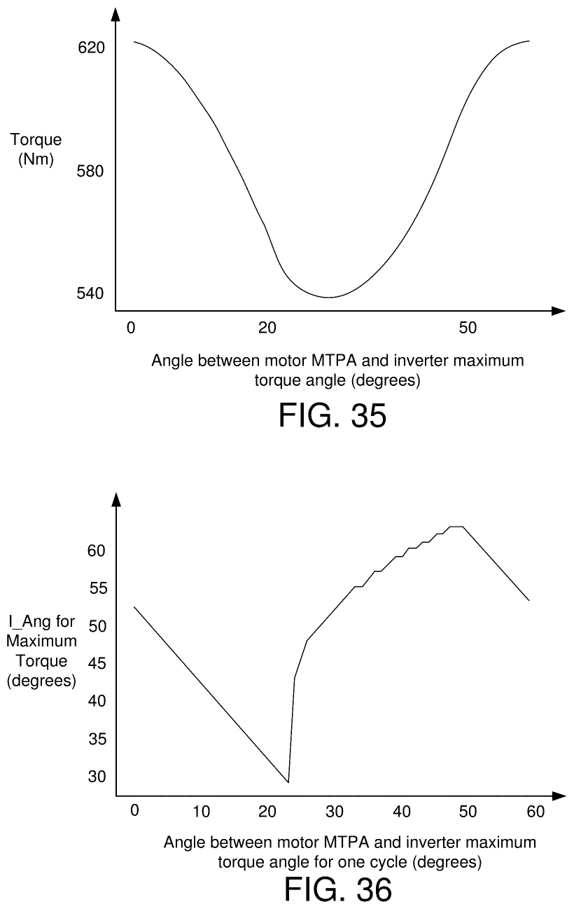

Referring now to FIG. 35, a plot of electric machine torque output verses the angle between motor MTPA and inverter maximum torque angle (degrees). The vertical axis represents electric machine torque output in Newton-meters (N-m) and the horizontal axis represents the angle between motor MTPA and inverter maximum torque angle. The operating conditions of this plot are that there are 30 angular degrees between the motor MTPA angle and the inverter maximum torque angle at zero angular degrees of electric machine rotation.

Line 3502 represents a relationship between electric machine torque output and the angle between motor MTPA and inverter maximum torque angle when there are 30 degrees of difference between the motor MTPA angle and the inverter maximum torque angle at zero rotational electric machine speed.

Referring now to FIG. 36, a plot of electric machine dq phase angle (I_Ang) for maximum electric machine torque verses angle between motor MTPA and inverter maximum torque angle (degrees) for one electric cycle of the machine. The vertical axis represents electric machine dq phase angle (I_Ang) for maximum electric machine torque in degrees and the horizontal axis represents the angle between motor MTPA and inverter maximum torque angle for one electric cycle of the machine. The operating conditions of this plot are that there are 30 angular degrees between the motor MTPA angle and the inverter maximum torque angle at zero angular degrees of electric machine rotation.

Line 3602 represents a relationship between electric machine dq phase angle for maximum electric machine torque output and the angle between motor MTPA and inverter maximum torque angle for one cycle when there are 30 degrees of difference between the motor MTPA angle and the inverter maximum torque angle at zero rotational electric machine speed.

Referring now to FIG. 37, a block diagram 3700 of a method for generating a dq phase angle (I_Ang) for commanding electric machine torque is shown. The method of block diagram 3700 may be stored as executable instructions in non-transitory memory of one or more controllers. Method 3700 may operate in coordination with the system of FIG. 1 and other methods disclosed herein to generate a dq current phase angle (I_Ang). The dq phase angle (I_Ang) determined in the method of FIG. 37 may be applied to a controller to control electric machine torque at zero and lower electric machine rotational speeds.

The maximum electric current for the present electric machine speed and a target torque are input to block 3704. The maximum electric current may be determined via a function or lookup table that is referenced by the present rotational speed of the electric machine. The target torque may be determined as a function of driver demand pedal position. At block 3704, the maximum electric current and target torque reference a table or function that outputs a maximum motor torque per ampere angle at zero electric machine rotational speed (I_Angₘₐₓ₀) according to the target torque and the maximum electric current. The table or function may be populated with I_Angₘₐₓ₀ values that are based on plots or functions as shown in FIG. 3. Block 3704 outputs the I_Angₘₐₓ₀ value to summing junction 3706.

Measured electric machine current is input to block 3702. Block 3702 determines currents for each of the motor phased supplied by the inverter legs and determines an angular degree value according to currents in each motor phase in which the machine torque will be maximized if the effect of MTPA graph is not considered (MTPA graph is assumed totally flat). The angular degree value is applied in conjunction with a torque map that relates angular degrees to normalized electric machine torque output. The map outputs the inverter maximum torque angle to summing junction 3706.

At summing junction 3706, the inverter maximum torque angle is subtracted from the maximum motor torque per ampere angle at zero electric machine rotational speed to generate the difference between the maximum motor torque per ampere angle at zero electric machine rotational speed and the maximum motor torque per ampere angle. The difference angle is input to block 3708.

At block 3708, the method of FIG. 16 is performed and the resulting dq phase angle (I_Ang) is output. In this way, the dq phase angle (I_Ang), which is an adjusted value here (e.g., gamma), is generated from the angular difference between the maximum motor torque per ampere angle at zero electric machine rotational speed and the maximum motor torque per ampere angle.

Referring now to FIG. 38, a block diagram of a method for determining a dq phase angle (I_Ang) that is based on electric machine speed is shown. The method of block diagram 3800 may be stored as executable instructions in non-transitory memory of one or more controllers. Method 3800 may operate in coordination with the system of FIG. 1 and other methods disclosed herein to generate a dq current phase angle (I_Ang) that is based on electric machine speed. The dq phase angle (I_Ang) determined in the method of FIG. 38 may be applied to a controller to control electric machine torque at a range of electric machine rotational speeds.

At block 3802, the maximum electric current and target torque reference a table or function that outputs a maximum motor torque per ampere angle at zero electric machine rotational speed (I_Angₘₐₓ₀) according to the target torque and the maximum electric current. The table or function may be populated with I_Angₘₐₓ₀ values that are based on plots or functions as shown in FIG. 3. Block 3802 outputs the I_Angₘₐₓ₀ angle to block 3806.

At block 3804, the target motor torque, maximum motor current, present motor current, and present angle of the motor are applied to generate a dq phase angle (I_Ang) value according to the method of FIG. 37. The I_Ang value that is based on the difference between the maximum motor torque per ampere angle at zero electric machine rotational speed and the maximum motor torque per ampere angle is output to block 3806.

Block 3806 may switch between outputting the angle between the maximum motor torque per ampere angle at zero electric machine rotational speed and the maximum motor torque per ampere angle, and outputting the maximum motor torque per ampere angle at zero electric machine rotational speed (I_Angₘₐₓ₀) as the dq phase angle (I_Ang). For example, for electric machine rotational speeds that are less than a threshold rotational speed, block 3806 outputs the angle between the maximum motor torque per ampere angle at zero electric machine rotational speed and the maximum motor torque per ampere angle to block 3808. For electric machine rotational speeds that are greater than the threshold rotational speed, block 3806 outputs the maximum motor torque per ampere angle at zero electric machine rotational speed (I_Angₘₐₓ₀) to block 3808.

At block 3808, the direct current and quadrature current that meet the requested or target electric machine torque and the dq phase angle (I_Ang) are generated and the electric machine is operated with these currents.

Thus, at lower electric machine rotational speeds, a value of I_Ang that is based on the angle between the maximum motor torque per ampere angle at zero electric machine rotational speed and the maximum motor torque per ampere angle may be applied to determine direct or d electric machine current and quadrature or q electric machine current. At higher electric machine rotational speeds, a value of I_Ang that is based on the maximum motor torque per ampere angle at zero electric machine rotational speed (I_Angₘₐₓ₀). The methods herein provide for a method for operating an electric machine, comprising: via a controller, generating a dq phase angle in response to a motor maximum torque per ampere angle and an inverter current angle; and operating the electric machine according to the dq phase angle. In a first example, the method includes where the dq phase angle is an angle between a direct current and a quadrature current of the electric machine. In a second example that may include the first example, the method includes where the motor maximum torque per ampere angle is based on a maximum electric machine current. In a third example that may include one or both of the first and second examples, the method includes where the dq phase angle is based on a difference between the motor maximum torque per ampere angle and the inverter current angle. In a fourth example that may include one or more of the first through third examples, the method includes where the dq phase angle is determined for zero rotational speed of the electric machine. In a fifth example that may include one or more of the first through fourth examples, the method includes where the inverter current angle is an angle of inverter current with respect to one cycle of a frequency of current output by the inverter for a particular phase leg of the inverter. In a sixth example that may include one or more of the first through fifth examples, the method includes where the motor maximum torque per ampere angle is a rotor angle of the electric machine where the electric machine outputs a maximum torque value for a particular electric machine current. In a seventh example that may include one or more of the first through sixth examples, the method includes where operating the electric machine according to the dq phase angle includes generating a quadrature current and a direct current for the electric machine via an inverter.

The methods herein also provide for a method for operating an electric machine, comprising: via a controller, during a first condition, generating a dq phase angle in response to a sole angle, the sole angle a first angle; via the controller, during a second condition, generating the dq phase angle in response to the first angle and a second angle; and operating the electric machine according to the dq phase angle. In a first example, the method includes where the first condition is a rotational speed of the electric machine being greater than a threshold speed, and where the second condition is the rotational speed of the electric machine being less than the threshold speed. In a second example that may include the first example, the method includes where the first angle is a motor maximum torque per ampere angle. In a third example that may include one or both of the first and second examples, the method includes where the motor maximum torque per ampere angle is based on a maximum electric machine current. In a fourth example that may include one or more of the first through third examples, the method includes where the dq phase angle is based on a difference between the first angle and the second angle.

Note that the example control and estimation routines included herein may be used with various powertrain and/or vehicle system configurations. The control methods and routines disclosed herein may be stored as executable instructions in non-transitory memory and may be carried out by the control system including the controller in combination with the various sensors, actuators, and other transmission and/or vehicle hardware. Further, portions of the methods may be physical actions taken in the real world to change a state of a device. Thus, the described actions, operations and/or functions may graphically represent code to be programmed into non-transitory memory of the computer readable storage medium in the vehicle and/or transmission control system. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the examples described herein, but is provided for case of illustration and description. One or more of the illustrated actions, operations and/or functions may be repeatedly performed depending on the particular strategy being used. One or more of the method steps described herein may be omitted if desired.

While various embodiments have been described above, it is to be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. For example, the above technology may be applied to electric vehicles and hybrid vehicles including induction and synchronous electric machines. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims may be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for operating an electric machine, comprising:
via a controller, generating a dq phase angle in response to a motor maximum torque per ampere angle and an inverter current angle; and
operating the electric machine according to the dq phase angle.

2. The method of claim 1, where the dq phase angle is an angle between a direct current and a quadrature current of the electric machine.

3. The method of claim 1, where the motor maximum torque per ampere angle is based on a maximum electric machine current.

4. The method of claim 1, where the dq phase angle is based on a difference between the motor maximum torque per ampere angle and the inverter current angle.

5. The method of claim 1, where the dq phase angle is determined for zero rotational speed of the electric machine.

6. The method of claim 1, where the inverter current angle is an angle of inverter current with respect to one cycle of a frequency of current output by the inverter for a particular phase leg of the inverter.

7. The method of claim 1, where the motor maximum torque per ampere angle is a rotor angle of the electric machine where the electric machine outputs a maximum torque value for a particular electric machine current.

8. The method of claim 1, where operating the electric machine according to the dq phase angle includes generating a quadrature current and a direct current for the electric machine via an inverter.

9. A system for operating an electric machine, comprising:
a controller including executable instructions that cause the controller to generate a dq phase angle in response to a motor maximum torque per ampere angle and an inverter current angle, and generate direct current and quadrature current to operate the electric machine according to the dq phase angle.

10. The system of claim 9, where the inverter current angle is an angle of inverter current with respect to one cycle of a frequency of current output by the inverter for a particular phase leg of the inverter.

11. The system of claim 9, where the dq phase angle is generated during a second condition in response to the motor maximum torque per ampere angle and the inverter current angle, and further comprising generating the dq phase angle during a first condition in response to a sole angle.

12. The system of claim 11, where the sole angle is the motor maximum torque per ampere angle.

13. The system of claim 12, where the second condition is a rotational speed of the electric machine being less than a threshold rotational speed.

14. The system of claim 9, where the dq phase angle is an angle between the direct current and the quadrature current of the electric machine.

15. The system of claim 9, where the motor maximum torque per ampere angle is based on a maximum electric machine current.

16. A method for operating an electric machine, comprising:
via a controller, during a first condition, generating a dq phase angle in response to a sole angle, the sole angle a first angle;
via the controller, during a second condition, generating the dq phase angle in response to the first angle and a second angle; and
operating the electric machine according to the dq phase angle.

17. The method of claim 16, where the first condition is a rotational speed of the electric machine being greater than a threshold speed, and where the second condition is the rotational speed of the electric machine being less than the threshold speed.

18. The method of claim 16, where the first angle is a motor maximum torque per ampere angle.

19. The method of claim 18, where the motor maximum torque per ampere angle is based on a maximum electric machine current.

20. The method of claim 16, where the dq phase angle is based on a difference between the first angle and the second angle.
